(19) United States
(12) Patent Application Publication
(10) Pub. No.: US 2026/0153791 A1
(43) Pub. Date: Jun. 4, 2026

(54) LENS BARREL AND CAMERA MODULE HAVING THE SAME

(71) Applicant: SAMSUNG ELECTRO-MECHANICS CO., LTD., Suwon-si (KR)

(72) Inventor: Jae Yeon PARK, Suwon-si (KR)

(73) Assignee: SAMSUNG ELECTRO-MECHANICS CO., LTD., Suwon-si (KR)

(21) Appl. No.: 19/332,654

(22) Filed: Sep. 18, 2025

(30) Foreign Application Priority Data
Nov. 29, 2024 (KR) 10-2024-0175247

(51) Int. Cl. G03B 17/12; G02B 7/02

(52) U.S. Cl. CPC G03B 17/12; G02B 7/02

(57) ABSTRACT

A camera module is provided. The camera module includes a barrel body configured to accommodate one or more lenses therein and including a flange that extends in a radial direction; a clamp configured to be coupled to the flange; and a housing configured to be coupled to the clamp. The camera module is firmly coupled between the lens barrel and the housing, and the flange is formed of a material that is different from a material of the clamp.

### CROSS-REFERENCE TO RELATED APPLICATIONS

This application claims the benefit under 35 USC § 119(a) of Korean Patent Application No. 10-2024-0175247 filed on Nov. 29, 2024, in the Korean Intellectual Property Office, the entire disclosure of which is incorporated herein by reference for all purposes.

### BACKGROUND

### 1. Field

The following description relates to a lens barrel and a camera module including the same.

### 2. Description of Related Art

Compact camera modules may include a lens barrel. The lens barrel is configured to accommodate one or more lenses, and may be formed of a plastic material to enable the camera module to be lightweight. Additionally, the lens barrel may be manufactured by injection molding to enable precise alignment of the lens, and precise coupling with the lens. However, such plastic material lens barrels are vulnerable to thermal shock, and may experience thermal deformation, making them difficult to couple to the metal housing of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens barrel includes a barrel body configured to accommodate one or more lenses therein; a flange disposed on an external circumferential surface of the barrel body; and a clamp configured to be coupled to the flange.

A material of the barrel body may be different from a material of the clamp.

The flange and the clamp may be coupled through a protrusion and a groove.

The flange and the clamp may be coupled by a screw fastening device.

A groove that extends in a radial direction may be formed on one surface of the clamp.

The groove may be formed at intervals along a circumferential direction of the clamp.

The lens barrel may further include an adhesive material that is disposed between the external circumferential surface of the barrel body and an internal circumferential surface of the clamp.

In a general aspect, a camera module may include a barrel body configured to accommodate one or more lenses therein and a flange that extends in a radial direction; a clamp that is coupled to the flange; and a housing that is coupled to the clamp;

The flange may be formed of a material that is different from a material of the clamp.

The clamp includes wrinkles that may be configured to increase a contact area of the clamp with the housing.

The flange or the clamp may be configured to enable a forced fit between the flange and the clamp.

The barrel body may be formed with a partition that partially divides a lens accommodating space in the barrel body.

The camera module may further include an adhesive material that is disposed between the barrel body and the clamp.

The camera module may further include a cover member that may be configured to be coupled to the barrel body and is further configured to restrict the one or more lenses within the barrel body.

In a general aspect, a camera module includes a barrel body configured to accommodate a plurality of lenses; a flange disposed on an external circumferential surface of the barrel body, and including a plurality of grooves that are alternately disposed in predetermined intervals on an external surface of the flange; and a clamp, configured to be coupled to the flange, and including a plurality of protrusions that are disposed at predetermined intervals along an internal circumferential surface of the clamp.

Other features and aspects will be apparent from the following detailed description, the drawings, and the claims.

### BRIEF DESCRIPTION OF DRAWINGS

FIG. 1 illustrates an exploded perspective view of an example lens barrel, in accordance with one or more embodiments.

FIG. 2 illustrates a perspective view of the example lens barrel illustrated in FIG. 1.

FIG. 3 illustrates a cross-sectional view of the example lens barrel illustrated in FIG. 2.

FIG. 4 illustrates an exploded perspective view of an example lens barrel, in accordance with one or more embodiments.

FIG. 5 illustrates an assembled perspective view of the example lens barrel illustrated in FIG. 4.

FIG. 6 illustrates a cross-sectional view of the example lens barrel illustrated in FIG. 5.

FIG. 7 illustrates an exploded perspective view of an example lens barrel, in accordance with one or more embodiments.

FIG. 8 illustrates an assembled perspective view of the example lens barrel illustrated in FIG. 7.

FIG. 9 illustrates a cross-sectional view of the example lens barrel illustrated in FIG. 8.

FIG. 10 illustrates an exploded perspective view of an example lens barrel, in accordance with one or more embodiments.

FIG. 11 illustrates an assembled perspective view of the example lens barrel illustrated in FIG. 10.

FIG. 12 illustrates a cross-sectional view of the example lens barrel illustrated in FIG. 11.

FIG. 13 illustrates an exploded perspective view of an example camera module, in accordance with one or more embodiments.

FIG. 14 illustrates an assembled perspective view of the example camera module illustrated in FIG. 13.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but may be used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

An example lens barrel, in accordance with one or more embodiments, may be mounted on a camera module. In a non-limited example, the lens barrel may be mounted on a camera module for a mobile terminal, a camera module for a surveillance camera, a camera module for a vehicle, or the like. However, the electronic devices on which the example camera module may be mounted are not limited to the devices described above.

The camera module, in accordance with one or more embodiments, may be mounted on a compact electronic device. In an example, the camera module may be mounted on a portable terminal, laptop, Virtual Reality (VR) device, glasses, or the like. However, the electronic devices on which the example camera module may be mounted are not limited to the devices described above. As an example, the camera module may be mounted on any portable electronic device, such as, but not limited to, a portable game console.

The example camera module, in accordance with one or more embodiments, may be mounted on a mechanical device. In an example, the camera module may be mounted in a passenger car, truck, construction equipment, or the like. However, the example mechanical devices on which the camera module may be mounted are not limited to the examples described above. As an example, the camera module may be mounted on an aerial vehicle such as a drone, or the like.

One or more examples may provide a lens barrel that is configured to be easily coupled to a housing formed of different materials.

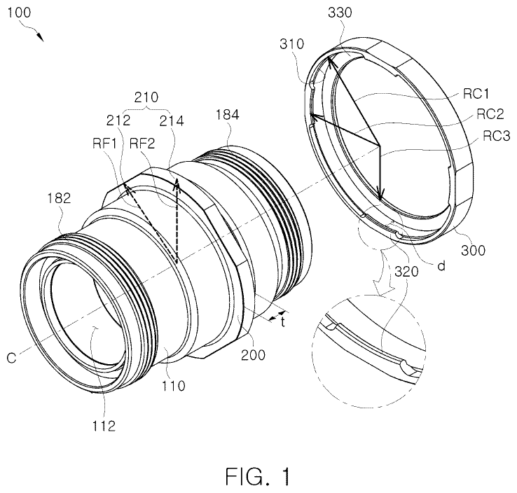

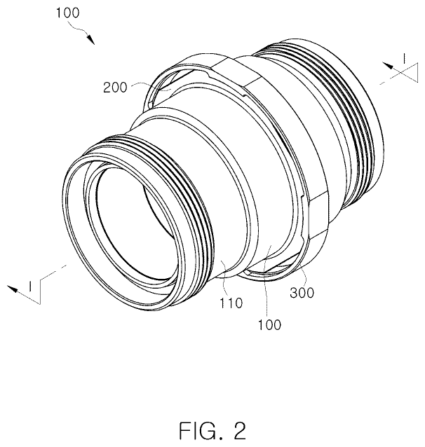

First, a lens barrel, in accordance with one or more embodiments, will be described with reference to FIGS. 1 to 3.

A lens barrel 100, in accordance with one or more embodiments, may include a barrel body 110, a flange 200, and a clamp 300. However, the configuration of the lens barrel 100 is not limited to the above-described members. As an example, the lens barrel 100 may further include one or more lenses accommodated inside the barrel body 110. As another example, the lens barrel 100 may further include a spacer accommodated inside the barrel body 110, and the spacer may be configured to maintain a distance between the lenses.

Next, the barrel body 110, the flange 200, and the clamp 300 configuring the lens barrel 100 will be described.

In an example, the barrel body 110 may be formed substantially in a cylindrical shape. However, the shape of the barrel body 110 is not limited to a cylinder. For example, the barrel body 110 may be deformed into other shapes within a range that may accommodate one or more lens. The barrel body 110 may include an accommodation space 112 that accommodates one or more lens. The accommodation space 112 may be formed along a longitudinal direction of the barrel body 110. To elaborate, the accommodation space 112 may be formed in a completely open form from a first end of the barrel body 110 to a second end of the barrel body 110.

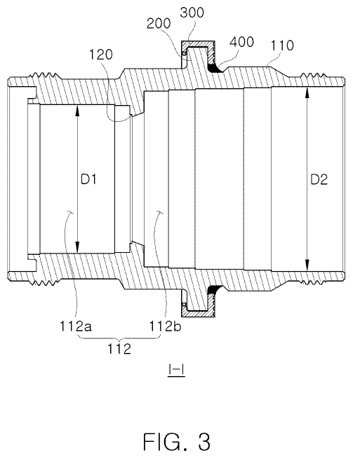

Referring to FIG. 3, the accommodation space 112 may be divided into a plurality of spaces 112a and 112b. For example, the accommodation space 112 may be divided into a first space 112a and a second space 112b with a partition wall 120 formed inside the barrel body 110 as illustrated in FIG. 3. However, the number of the accommodation space 112 divided by the partition wall 120 is not limited to two. For example, the accommodation space 112 may be divided into three or more spaces by a plurality of partition walls 120 formed inside the barrel body 110.

Each of a first space 112a and a second space 112b may be configured to have cross-sectional areas of different sizes. For example, a first diameter D1 of the first space 112a may have a different size from a second diameter D2 of the second space 112b. The first space 112a and the second space 112b configured in this manner may be advantageous in accommodating and supporting lenses of different sizes. However, the cross-sectional areas of the first space 112a and the second space 112b are not necessarily different. For example, depending on a type of optical imaging system accommodated inside the barrel body 110, the first diameter D1 of the first space 112a and the second diameter D2 of the second space 112b may be formed to have the same size.

The barrel body 110 may be configured to be easily coupled to other members configuring the camera module. For example, screw threads 182 and 184 may be formed on the front end and the rear end of the barrel body 110. However, the threads 182 and 184 are not necessarily formed on the front end and the rear end of the barrel body 110. As an example, it may be possible to form the threads 182 and 184 only on the front end or rear end of the barrel body 110.

The flange 200 may be formed on the barrel body 110. For example, the flange 200 may be formed between the front end and the rear end of the barrel body 110. The flange 200 may be formed to avoid overlapping the partition wall 120 of the barrel body 110. For example, the flange 200 may be formed at a predetermined distance from the partition wall 120 as illustrated in FIG. 3. For reference, this structure may be advantageous in improving the rigidity of the barrel body 110.

The flange 200 may be formed of the same or similar material as the barrel body 110, and may be formed integrally with the barrel body 110. For example, the flange 200 and the barrel body 110 may be manufactured simultaneously through one molding process. The flange 200 may include an external circumferential surface 210 of different shapes. For example, the flange 200 may include a first external circumferential portion 212 formed substantially straight and a second external circumferential portion 214 formed substantially curved. The first external circumferential portion 212 and the second external circumferential portion 214 may be formed alternately along the external circumferential surface 210 of the flange 200. For example, four first external circumferential portions 212 and four external circumferential portions 214 may be formed alternately along the external circumferential surface 210 of the flange portion 200. A distance from an optical axis C to the first external circumferential portion 212 and the second external circumferential portion 214 may be different. For example, a distance RF1 from the optical axis C to the outermost point of the first external circumferential portion 212 may be less than a distance RF2 from the optical axis C to the outermost point of the second external circumferential portion 214.

The clamp 300 may be configured to have different characteristics from the barrel body 110 and the flange 200. For example, the clamp 300 may be formed of a material having better heat resistance or rigidity than the barrel body 110 and the flange 200. As a specific example, the clamp 300 may be formed of aluminum. However, the material of the clamp 300 is not limited to aluminum.

The clamp 300 may be configured to be coupled to the flange 200. For example, the clamp 300 may be fitted to the barrel body 110 through the front end and rear end of the barrel body 110 and then coupled to the flange 200. The clamp 300 may be configured to be firmly coupled to the flange 200. For example, the clamp 300 may be coupled to the flange 200 in a manner of a protrusion and a groove. As a specific example, one or more or protrusions 320 may be formed on the clamp 300. The protrusions 320 may be formed or disposed at a predetermined intervals along an internal circumferential surface 310 of the clamp 300. For example, a plurality of protrusions 320 may be formed or disposed at substantially the same or similar intervals as the first external circumferential portion 212 of the flange 200. In an example, the circumferential portion 212 of the flange 200 may correspond to a groove. However, a disposition of the protrusions 320 is not necessarily the same, or similar to, the first external circumferential portion 212 of the flange 200. For example, when the number of protrusions 320 is less than the number of the first external circumferential portion 212, the protrusions 320 may be formed at intervals different from the disposition of the first external circumferential portion 212. The clamp 300 may include a rib 330 configured to contact the front or rear end of the flange 200. The rib 330 may be formed at a predetermined distance d from the protrusion 320. The distance d between the rib 330 and the protrusion 320 may be substantially greater than a thickness t of the flange 200.

Distances RC1, RC2, and RC3 from the optical axis C to the internal circumferential surface 310, protrusion 320, and rib 330 of the clamp 300 may have a predetermined size relationship with distances RF1 and RF2 from the optical axis C to the first external circumferential portion 212 and the second external circumferential portion 214. As an example, the distance RC2 from the optical axis C to an end of the protrusion 320 may be greater than the distance RF1 from the optical axis C to the first external circumferential portion 212 and smaller than the distance RF2 from the optical axis C to the second external circumferential portion 214. As another example, the distance RC2 from the optical axis C to the internal circumferential surface 310 of the clamp 300 may be greater than both the distance RF1 from the optical axis C to the first external circumferential portion 212 and the distance RF2 from the optical axis C to the second external circumferential portion 214. Additionally, the distance RC3 from the optical axis C to the front of the rib 330 may be less than the distance RF1 from the optical axis C to the first external circumferential portion 212.

The clamp 300 that is configured in this manner may be fitted to the flange 200 with the protrusion 320 disposed to correspond to the first external circumferential portion 212 of the flange 200. Additionally, the clamp 300 that is fitted to the flange 200 may be firmly coupled to the flange 200 so that it may not fall out the barrel body 110 when the protrusion 320 is rotated clockwise or counterclockwise to correspond to the second external circumferential portion 214.

The lens barrel 100, in accordance with one or more embodiments, may further include a configuration that improves a binding force of the flange 200 and the clamp 300. For example, referring to FIG. 3, the lens barrel 100 may further include an adhesive member 400. The adhesive member 400 may be applied to a gap between the flange 200 and the clamp 300 or a gap between the clamp 300 and the barrel body 110 as illustrated in FIG. 3. However, the application space for the adhesive member 400 is not limited to the example forms described above.

The lens barrel 100, in accordance with one or more embodiments, may be configured of different materials. For example, the barrel body 110 and flange 200 may be formed of a different material from the clamp 300. As a specific example, the barrel body 110 and the flange 200 may be formed of plastic materials, and the clamp 300 may be formed of metal materials. The lens barrel 100 that is configured in this manner may enable the lens barrel 100 to have a light weight since the barrel body 110 which occupies a significant portion of the lens barrel 100, is formed of plastic materials. Additionally, the lens barrel 100, in accordance with one or more embodiments, may be coupled to another metal member (e.g., a housing of a camera module) via the clamp 300 that is coupled to the barrel body 110.

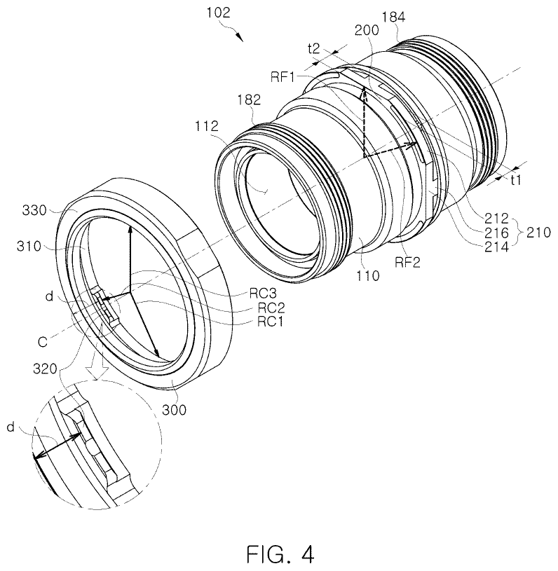

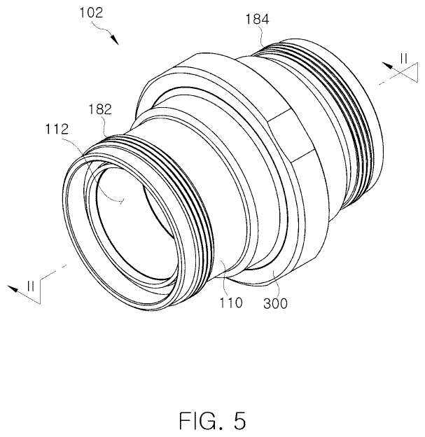

Next, an example lens barrel according to another embodiment will be described with reference to FIGS. 4 to 6.

A lens barrel 102 according to the embodiment may include a barrel body 110, a flange 200, and a clamp 300. However, the configuration of the lens barrel 102 is not limited to the above-described members. As an example, the lens barrel 102 may further include one or more lenses accommodated inside the barrel body 110. As another example, the lens barrel 102 may further include a spacer accommodated inside the barrel body 110 and maintaining a distance between the lenses.

Next, the barrel body 110, the flange 200, and the clamp 300 configuring the lens barrel 102 will be described.

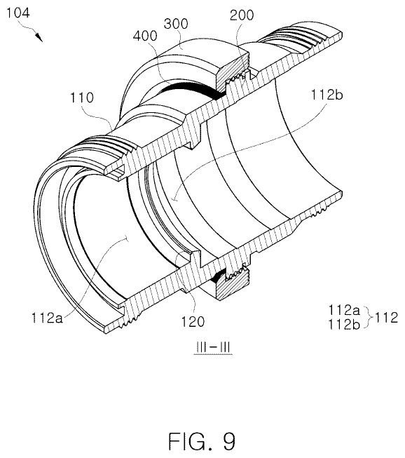

The barrel body 110 may be formed in a substantially cylindrical shape. However, the shape of the barrel body 110 is not limited to a cylinder. For example, the barrel body 110 may be deformed into other shapes within a range that may accommodate a lens. The barrel body 110 may include the accommodation space 112 that accommodates the lens. The accommodation space 112 may be formed in a longitudinal direction of the barrel body 110. To elaborate, the accommodation space 112 may be formed in a completely open form from a first end of the barrel body 110 to a second end of the barrel body 110. The accommodation space 112 may be divided into a plurality of spaces 112a and 112b. For example, the accommodation space 112 may be divided into the first space 112a and the second space 112b based on the partition wall 120 formed inside the barrel body 110 as illustrated in FIG. 9. However, the number of accommodation space 112 divided by the partition wall 120 is not limited to two. For example, the accommodation space 112 may be divided into three or more spaces by a plurality of partition walls 120 formed inside the barrel body 110.

The barrel body 110 may be configured to be easily coupled to other members configuring the camera module. For example, threads 182 and 184 may be formed on the front end and rear end of the barrel body 110. However, the threads 182 and 184 are not necessarily formed on the front end and rear end of the barrel body 110. As an example, it may be possible to form the threads 182 and 184 only on the front end or rear end of the barrel body 110.

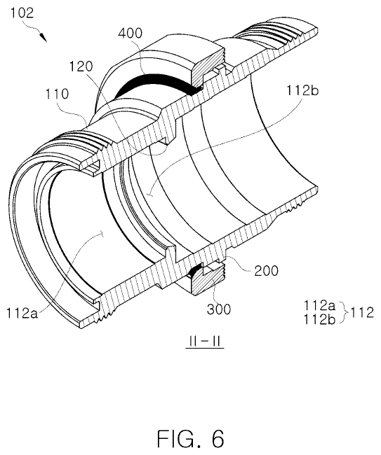

The flange 200 may be formed on the barrel body 110. For example, the flange 200 may be formed between the front end and rear end of the barrel body 110. The flange 200 may be formed to avoid overlapping the partition wall 120 of the barrel body 110. For example, the flange 200 may be formed at a predetermined distance from the partition 120 as illustrated in FIG. 6. For reference, this structure may be advantageous in improving the rigidity of the barrel body 110.

The flange 200 may be formed of the same or similar material as the barrel body 110, and may be formed integrally with the barrel body 110. In an example, the flange 200 and the barrel body 110 may be manufactured simultaneously through one molding process. The flange 200 may include the external circumferential surface 210 of different shapes. For example, the flange 200 may include a first external circumferential portion 212 that is substantially curved and a second external circumferential portion 214 that is substantially straight. The first external circumferential portion 212 and the second external circumferential portion 214 may be formed alternately along the external circumferential surface 210 of the flange 200. For example, four first external circumferential portion 212 and four external circumferential portion 214 may be formed alternately along the external circumferential surface 210 of the flange portion 200. A distance from the optical axis C to the first external circumferential portion 212 and the second external circumferential portion 214 may be different. For example, a distance RF1 from the optical axis C to the outermost point of the first external circumferential portion 212 may be greater than a distance RF2 from the optical axis C to the outermost point of the second external circumferential portion 214. In the embodiment, the second external circumferential portion 214 may further include a unique configuration. For example, in the second external circumferential portion 214, a reinforcing portion 216 extending in the longitudinal direction of the barrel body 110 may be further formed. Accordingly, the first external circumferential portion 212 and the second external circumferential portion 214 may have different thicknesses. For example, a maximum thickness t1 of the first external circumferential portion 212 may be less than a maximum thickness t2 of the second external circumferential portion 214.

In an example, the clamp 300 may be configured to have different characteristics from the barrel body 110 and the flange 200. For example, the clamp 300 may be formed of a material having better (or a higher) heat resistance or rigidity than the barrel body 110 and the flange 200. As a specific example, the clamp 300 may be formed of aluminum material. However, the material of the clamp 300 is not limited to aluminum.

The clamp 300 may be configured to be coupled to the flange 200. For example, the clamp 300 may be fitted to the barrel body 110 through the front end or rear end of the barrel body 110 and then coupled to the flange 200. The clamp 300 may be configured to be firmly coupled to the flange 200. For example, the clamp 300 may be formed with one or more protrusions 320. The protrusions 320 may be formed at a predetermined interval along the internal circumferential surface 310 of the clamp 300. In an example, a plurality of protrusions 320 may be formed at substantially the same or similar intervals as the second external circumferential portion 214 of the flange 200. However, a disposition of the protrusions 320 is not necessarily same, or similar to, the second external circumferential portion 214 of the flange 200. For example, when the number of protrusions 320 is less than the number of the second external circumferential portion 214, the protrusions 320 may be formed at intervals different from the disposition of the second external circumferential portion 214. The clamp 300 may include the rib 330 configured to contact the front or rear end of the flange 200. The rib 330 may be formed at a predetermined distance d from the protrusion 320. The distance d between the rib 330 and the protrusion 320 may be greater than the thickness t1 of the first external circumferential portion 212 and equal to or less than the thickness t2 of the second external circumferential portion 214.

The distances RC1, RC2, and RC3 from the optical axis C to the internal circumferential surface 310, protrusion 320, and rib 330 of the clamp 300 may have a predetermined size relationship with the distances RF1 and RF2 from the optical axis C to the first external circumferential portion 212 and the second external circumferential portion 214. As an example, the distance RC2 from the optical axis C to an end of the protrusion 320 may be same as or smaller than the distance RF1 from the optical axis C to the first external circumferential portion 212 and same as or greater than the distance RF2 from the optical axis C to the second external circumferential portion 214. As another example, the distance RC2 from the optical axis C to the internal circumferential surface 310 of the clamp 300 may be greater than both the distance RF1 from the optical axis C to the first external circumferential portion 212 and the distance RF2 from the optical axis C to the second external circumferential portion 214. Additionally, the distance RC3 from the optical axis C to the tip of the rib 330 may be less than the distance RF1 from the optical axis C to the first external circumferential portion 212.

The lens barrel 102 configured in this manner may achieve a firm connection between the clamp 300 and the flange 200 by rotating the clamp 300 clockwise or counterclockwise while the clamp 300 is fitted to the flange 200. To elaborate, in the lens barrel 102 according to the embodiment, a firm connection between the clamp 300 and the flange 200 may be achieved by forcibly inserting the second external circumferential portion 214 or the reinforcing portion 216 of the second external circumferential portion 214 between the protrusion 320 and the rib 330.

Referring to FIG. 6, the lens barrel 102 according to the embodiment may further include a configuration to improve the binding force of the flange 200 and the clamp 300. For example, the lens barrel 102 may further include an adhesive member 400. The adhesive member 400 may be applied to a gap between the flange 200 and the clamp 300 or a gap between the clamp 300 and the barrel body 110 as illustrated in FIG. 6. However, the application space of the adhesive member 400 is not limited to the example form described above.

The lens barrel 102 according to the embodiment may be configured of different materials. In an example, the barrel body 110 and flange 200 may be formed of different materials from a material of the clamp 300. As a specific example, the barrel body 110 and the flange 200 may be formed of plastic materials, and the clamp 300 may be formed of metal materials. A lens barrel 102 configured in this manner may enable the lens barrel 102 to have a light weight, since the barrel body 110 occupying a significant portion of the lens barrel 102 is formed of plastic materials. Additionally, the lens barrel 102 according to the embodiment may be coupled to another metal member (e.g., a housing of a camera module) via the clamp 300 that is coupled to the barrel body 110.

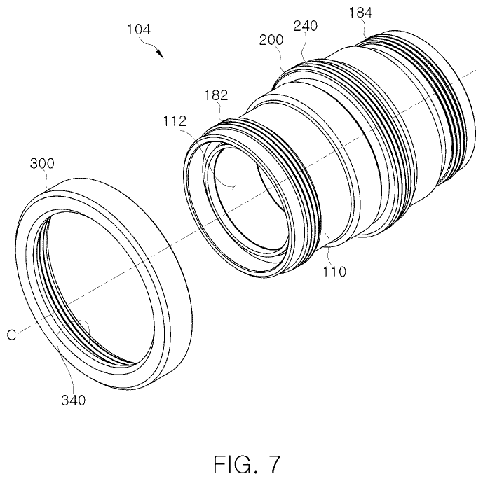

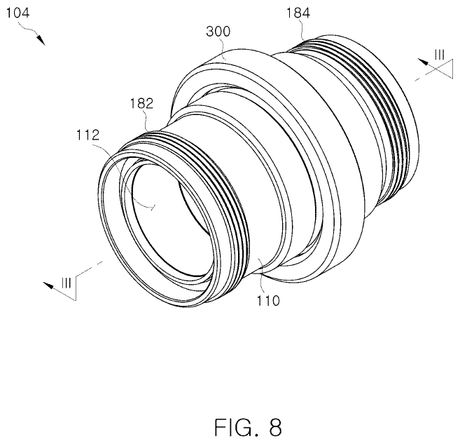

Next, a lens barrel according to another embodiment will be described with reference to FIGS. 7 to 9.

A lens barrel 104 according to the embodiment may include a barrel body 110, a flange 200, and a clamp 300. However, the configuration of the lens barrel 104 is not limited to the above-described members. As an example, the lens barrel 104 may further include one or more lenses accommodated inside the barrel body 110. As another example, the lens barrel 104 may further include a spacer accommodated inside the barrel body 110 and configured to maintain a distance between the lenses.

Next, the barrel body 110, the flange 200, and the clamp 300 configuring the lens barrel 104 will be described.

The barrel body 110 may be formed substantially in a cylindrical shape. However, the shape of the barrel body 110 is not limited to a cylinder. For example, the barrel body 110 may be deformed into other shapes within a range that may accommodate a lens. The barrel body 110 may include the accommodation space 112 that accommodates the lens. The accommodation space 112 may be formed along a longitudinal direction of the barrel body 110. To elaborate, the accommodation space 112 may be formed in a completely open form from a first end of the barrel body 110 to a second end of the barrel body 110. The accommodation space 112 may be divided into a plurality of spaces 112a and 112b. For example, the accommodation space 112 may be divided into the first space 112a and the second space 112b based on the partition wall 120 formed inside the barrel body 110 as illustrated in FIG. 9. However, the number of accommodation space 112 divided by the partition wall 120 is not limited to two. For example, the accommodation space 112 may be divided into three or more spaces by a plurality of partition walls 120 formed inside the barrel body 110.

The barrel body 110 may be configured to be easily coupled to other members configuring the camera module. For example, threads 182 and 184 may be formed on the front end and rear end of the barrel body 110. However, the threads 182 and 184 are not necessarily formed on the front end and rear end of the barrel body 110. As an example, it may be possible to form the threads 182 and 184 only on the front end or only on the rear end of the barrel body 110.

The flange 200 may be formed on the barrel body 110. For example, the flange 200 may be formed between the front end and rear end of the barrel body 110. The flange 200 may be formed to avoid overlapping the partition wall 120 of the barrel body 110. For example, the flange 200 may be formed at a predetermined distance from the partition 120 as illustrated in FIG. 9. For reference, this structure may be advantageous in improving the rigidity of the barrel body 110.

The flange 200 may be formed of the same material or similar material as the barrel body 110, and may be formed integrally with the barrel body 110. In an example, the flange 200 and the barrel body 110 may be manufactured simultaneously through one molding process. The flange 200 may include a unique configuration for coupling with the clamp 300. For example, the flange 200 according to the present embodiment may have a thread 240 formed thereon.

The clamp 300 may be configured to have different characteristics from the barrel body 110 and the flange 200. For example, the clamp 300 may be formed of a material having better (or a higher level of) heat resistance or rigidity than the barrel body 110 and the flange 200. As a specific example, the clamp 300 may be formed of aluminum material. However, the material of the clamp 300 is not limited to aluminum.

The clamp 300 may be configured to be coupled to the flange 200. For example, the clamp 300 may include a thread 340 configured to engage with the thread 240 of the flange 200. The thread 340 may be formed on the internal circumferential surface of the clamp 300.

The lens barrel 104 according to the embodiment may be configured of different materials. For example, the barrel body 110 and flange 200 may be formed of different materials from a material of the clamp 300. As a specific example, the barrel body 110 and the flange 200 may be formed of plastic materials, and the clamp 300 may be formed of metal materials. A lens barrel 104 configured in this manner may enable the lens barrel 104 to have a light weight since the barrel body 110 occupying a significant portion of the lens barrel 104 is formed of plastic materials. Additionally, the lens barrel 104 according to the embodiment may be coupled to another metal member (e.g., a housing of a camera module) via the clamp 300 coupled to the barrel body 110.

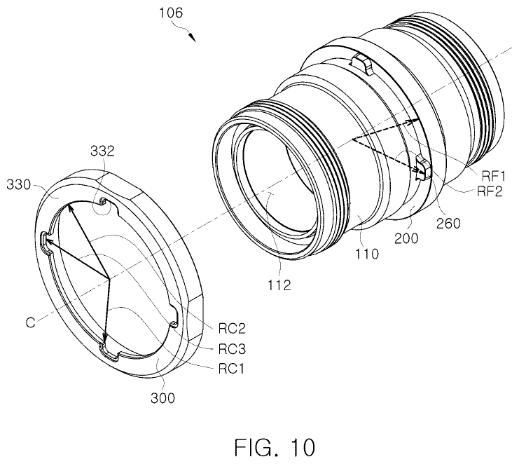

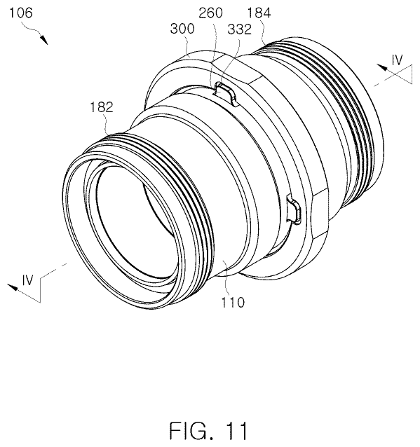

Next, a lens barrel according to another embodiment will be described with reference to FIGS. 10 to 12.

A lens barrel 106 according to the embodiment may include a barrel body 110, a flange 200, and a clamp 300. However, the configuration of the lens barrel 106 is not limited to the above-described members. As an example, the lens barrel 106 may further include one or more lenses accommodated inside the barrel body 110. As another example, the lens barrel 106 may further include a spacer accommodated inside the barrel body 110 and configured to maintain a distance between the lenses.

Next, the barrel body 110, the flange 200, and the clamp 300 configuring the lens barrel 106 will be described.

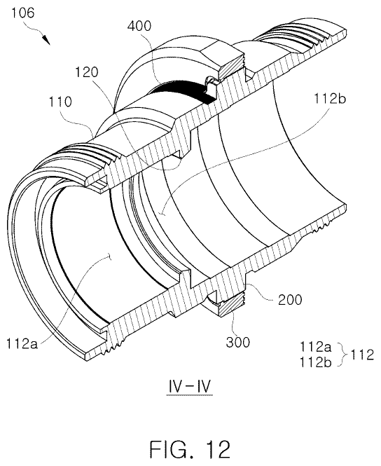

The barrel body 110 may be formed substantially in a cylindrical shape. However, the shape of the barrel body 110 is not limited to a cylinder. For example, the barrel body 110 may be deformed into other shapes within a range that may accommodate one or more lens. The barrel body 110 may include the accommodation space 112 that accommodates the lens. The accommodation space 112 may be formed along a longitudinal direction of the barrel body 110. To elaborate, the accommodation space 112 may be formed in a completely open form from a first end of the barrel body 110 to a second end of the barrel body 110. The accommodation space 112 may be divided into a plurality of spaces 112a and 112b. For example, the accommodation space 112 may be divided into the first space 112a and the second space 112b based on the partition wall 120 formed inside the barrel body 110 as illustrated in FIG. 12. However, the number of accommodation space 112 divided by the partition wall 120 is not limited to two. For example, the accommodation space 112 may be divided into three or more spaces by a plurality of partition walls 120 formed inside the barrel body 110.

The barrel body 110 may be configured to be easily coupled to other members configuring the camera module. For example, threads 182 and 184 may be formed on the front end and the rear end of the barrel body 110. However, the threads 182 and 184 are not necessarily formed on the front end and the rear end of the barrel body 110. As an example, it may be possible to form the threads 182 and 184 only on the front end or the rear end of the barrel body 110.

The flange 200 may be formed on the barrel body 110. For example, the flange 200 may be formed between the front end and the rear end of the barrel body 110. The flange 200 may be formed to avoid overlapping the partition wall 120 of the barrel body 110. For example, the flange 200 may be formed at a predetermined distance from the partition wall 120 as illustrated in FIG. 12. For reference, this structure may be advantageous in improving rigidity of the barrel body 110.

The flange 200 may be formed of the same material or similar material as the barrel body 110 and may be formed integrally with the barrel body 110. For example, the flange 200 and the barrel body 110 may be manufactured simultaneously through one molding process. Protrusions 260 may be formed on the flange 200. The protrusions 260 may be formed in a shape that protrudes from one side of the flange 200 as illustrated in FIG. 10. The protrusions 260 may be formed at a predetermined intervals along a circumferential direction of the flange 200. For example, in the embodiment, four protrusions 260 may be formed at a predetermined intervals on the front surface of the flange 200. However, the number of protrusions 260 formed on the flange 200 is not limited to four. The protrusions 260 may be formed to have substantially the same height as the external circumferential surface of the flange 200. For example, the distance RF1 from the optical axis C to the external circumferential surface of the flange 200 may be substantially the same as the distance RF2 from the optical axis C to the tip of the protrusion 260. However, RF1 and RF2 may not necessarily have the same size.

The clamp 300 may be configured to have different characteristics from the barrel body 110 and the flange 200. For example, the clamp 300 may be formed of a material having better (or a higher level of) heat resistance or rigidity than the barrel body 110 and the flange 200. As a specific example, the clamp 300 may be formed of aluminum material. However, the material of the clamp 300 is not limited to aluminum.

The clamp 300 may be configured to be firmly coupled to the flange 200. For example, a groove 332 having a shape corresponding to the protrusion 260 of the flange 200 may be formed in the clamp 300. To elaborate, the rib 330 of the clamp 300 may be formed with the same number of the grooves 332 as the protrusions 260. The grooves 332 extend radially from the internal circumferential surface 310 of the clamp 300, and may be formed at intervals along the circumferential direction of the clamp 300.

Distances RC1, RC2, and RC3 from the optical axis C to the internal circumferential surface 310, and rib 330, groove 332 of the clamp 300 may have a predetermined size relationship with distances RF1 and RF2 from the optical axis C to the flange 200 and the protrusion 260. For example, the distance RC3 from the optical axis C to the groove 332 may be substantially the same as, or greater than, the distance RF2 from the optical axis C to the tip of the protrusion 260. As another example, a distance RC1 from the optical axis C to the internal circumferential surface 310 of the clamp 300 may be greater than the distance RF1 from the optical axis C to the flange 200 and the distance RF2 from the optical axis C to the tip of the protrusion 260. As another example, a distance RC2 from the optical axis C to the rib 330 may be less than the distance RF1 from the optical axis C to the flange 200 and the distance RF2 from the optical axis C to the tip of the protrusion 260.

The lens barrel 106 configured in this manner may be coupled to the flange 200 and the clamp 300 through a multifaceted contact between the flange 200 and the protrusion 260 and the internal circumferential surface 310, rib 330, and groove 332 of the clamp 300.

Referring to FIG. 12, the lens barrel 106 according to the embodiment may further include a configuration to improve binding force of the flange 200 and the clamp 300. For example, the lens barrel 106 may further include an adhesive member 400. The adhesive member 400 may be applied to a gap between the flange 200 and the clamp 300 or a gap between the clamp 300 and the barrel body 110 as illustrated in FIG. 12. However, the application space for the adhesive member 400 is not limited to the example described above.

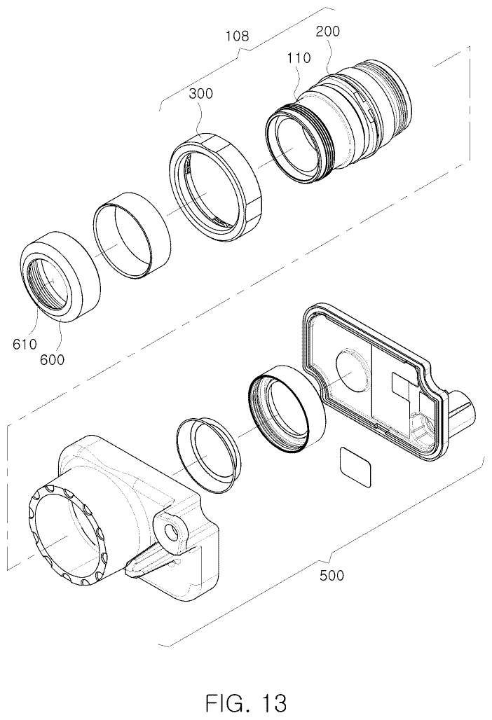

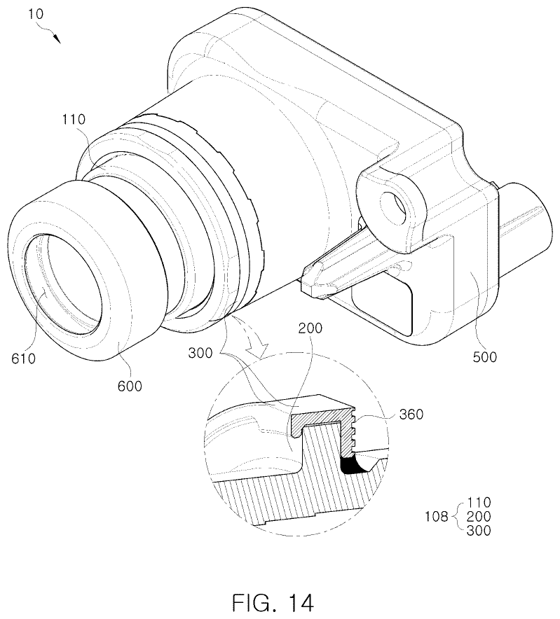

Next, a camera module according to an embodiment will be described with reference to FIGS. 13 to 14.

A camera module 10 according to the embodiment may include a lens barrel 108, a housing 500, and a cover member 600. However, the configuration of the camera module 10 is not limited to the above-described members. For example, the camera module 10 may further include one or more lens and an image sensor package disposed inside the lens barrel 108.

The lens barrel 108 may be one of the lens barrels 100, 102, 104, and 106 described above. To elaborate, the barrel body 110, the flange 200, and the clamp 300 configuring the lens barrel 108 may be formed in one of the forms illustrated in FIGS. 1 to 12 or in a combination of forms thereof.

As an example, the partition wall 120 may be formed in the barrel body 110 to divide a lens accommodation space 112. As another example, the flange 200 and the clamp 300 may be formed of different materials. Additionally, an external diameter of the flange 200 and an internal diameter of the clamp 300 may be configured to enable an interference fit. For example, the external diameter of the flange 200 and the internal diameter of the clamp 300 may have substantially the same size. As another example, an adhesive member 400 may be applied between the flange 200 and the clamp 300.

The camera module 10 according to the embodiment may include a clamp 300 having a unique shape. For example, in the embodiment, the clamp 300 may be configured to have a wrinkle 360 formed on a surface in contact with the housing 500. The wrinkles 360 of the clamp 300 may form a space between the clamp 300 and the housing 500 where an adhesive member may be applied or may facilitate welding joints between the clamp 300 and the housing 500.

The housing 500 may be configured to accommodate a portion of components of the camera module 10. For example, the housing 500 may be configured to accommodate an image sensor package. Additionally, the housing 500 may be configured to accommodate a portion of the lens barrel 108. The housing 500 may be formed of a material that withstands strong external impacts. For example, the housing 500 may be formed of a metal material. The housing 500 may be configured to facilitate coupling with the clamp 300. For example, the housing 500 may be formed of the same material or similar material as the clamp 300. The housing 500 configured in this manner may be permanently connected to the clamp 300 of the lens barrel 108 by a method such as spot welding or laser welding.

The cover member 600 may be coupled to the lens barrel 108. In an example, the cover member 600 may be coupled to the lens barrel 108 by a screw fastening method or device. However, the joint structure of the cover member 600 and the lens barrel 108 is not limited to a screw fastening method or device. The cover member 600 may be configured to prevent the lenses accommodated inside the lens barrel 108 from falling out. As an example, an opening 610 of the cover member 600 may be less than a maximum diameter of a lens (not illustrated) disposed at the foremost of the lens barrel 108.

The cover member 600 may be configured to prevent foreign substances from entering inside the camera module 10. In an example, the cover member 600 may have a protective glass disposed to prevent foreign substances from entering.

The lens barrel according to the one or more examples may be firmly coupled to a housing formed of different materials.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A lens barrel, comprising:
a barrel body configured to accommodate one or more lenses therein;
a flange disposed on an external circumferential surface of the barrel body; and
a clamp configured to be coupled to the flange.

2. The lens barrel of claim 1, wherein a material of the barrel body is different from a material of the clamp.

3. The lens barrel of claim 1, wherein the flange and the clamp are coupled through a protrusion and a groove.

4. The lens barrel of claim 1, wherein the flange and the clamp are coupled by a screw fastening device.

5. The lens barrel of claim 1, wherein a groove that extends in a radial direction is formed on one surface of the clamp.

6. The lens barrel of claim 5, wherein the groove is formed at intervals along a circumferential direction of the clamp.

7. The lens barrel of claim 1, further comprising an adhesive material that is disposed between the external circumferential surface of the barrel body and an internal circumferential surface of the clamp.

8. A camera module, comprising:
a barrel body configured to accommodate one or more lenses therein and comprising a flange that extends in a radial direction;
a clamp that is coupled to the flange; and
a housing coupled to the clamp.

9. The camera module of claim 8, wherein the flange is formed of a material that is different from a material of the clamp.

10. The camera module of claim 8, wherein the clamp is comprises wrinkles that are configured to increase a contact area of the clamp with the housing.

11. The camera module of claim 8, wherein the flange or the clamp is configured to enable a forced fit between the flange and the clamp.

12. The camera module of claim 8, wherein the barrel body is formed with a partition that partially divides a lens accommodating space in the barrel body.

13. The camera module of claim 8, further comprising an adhesive material that is disposed between the barrel body and the clamp.

14. The camera module of claim 8, further comprising a cover member that is configured to be coupled to the barrel body and is further configured to restrict the one or more lenses within the barrel body.

15. A camera module, comprising:
a barrel body configured to accommodate a plurality of lenses;
a flange disposed on an external circumferential surface of the barrel body, and including a plurality of grooves that are alternately disposed in predetermined intervals on an external surface of the flange; and
a clamp, configured to be coupled to the flange, and including a plurality of protrusions that are disposed at predetermined intervals along an internal circumferential surface of the clamp.
